(19) United States
(12) Patent Application Publication
(10) Pub. No.: US 2025/0336910 A1
(43) Pub. Date: Oct. 30, 2025

(54) SYSTEM AND METHOD OF PREFORMATION OF CATHODE ELECTROLYTE INTERPHASE ON CATHODE ACTIVE MATERIALS

(71) Applicants: GM Global Technology Operations LLC, Detroit, MI (US); UChicago Argonne, LLC, Chicago, IL (US)

(72) Inventors: Jeffrey David Cain, Royal Oak, MI (US); Nicholas Paul William Pieczonka, Troy, MI (US); Sayed Youssef Sayed Nagy, Troy, MI (US); Caleb Reese, Ferndale, MI (US); Colin Jamison, Livonia, MI (US); Zachary David Hood, Bolingbrook, IL (US); Shiba Adhikari, Lisle, IL (US)

(73) Assignees: GM Global Technology Operations LLC, Detroit, MI (US); UChicago Argonne, LLC, Chicago, IL (US)

(21) Appl. No.: 18/651,672

(22) Filed: Apr. 30, 2024

(51) Int. Cl. H01M 4/04; H01M 4/02; H01M 4/505

(52) U.S. Cl. CPC H01M 4/0407; H01M 4/505; H01M 2004/028

(57) ABSTRACT

A method for pre-forming cathode electrolyte interphase on electroactive material, the method comprising sourcing a current or voltage to an electrochemical reactor comprising a cation source, an electrolyte mixture, one or more additives, and a cathode active material in contact with one another, wherein the current or voltage serves to ionize and form cations at the cation source that reacts with the cathode active material to pre-form cathode electrolyte interphase on the cathode active material.

### GOVERNMENT FUNDING

This invention was made with Government support under Agreement No. DE-AC02-06CH11357 Ex Situ Lithiation for Li-Ion Battery Anodes awarded by the Department of Energy. The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electroactive materials, and more particularly, to pre-formed cathode electrolyte interphase, for use in electrochemical cells, and methods of making and using the same.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical batteries include at least two electrodes and an electrolyte and/or separator. One of the two electrodes may serve as a positive electrode or cathode and the other electrode may serve as a negative electrode or anode. A separator filled with a liquid, solid, or semi-solid electrolyte may be disposed between the negative and positive electrodes. The electrolyte is suitable for conducting ions (e.g., lithium ions, calcium ions, sodium ions, and/or potassium ions) between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Conventional rechargeable batteries operate by reversibly passing the ions back and forth between the negative electrode and the positive electrode. For example, the ions may move from the positive electrode to the negative electrode during charging of the battery, and in the opposite direction when discharging the battery. Such batteries can reversibly supply power to an associated load device on demand. More specifically, electrical power can be supplied to a load device by the battery until the lithium, calcium, sodium, and/or potassium content of the negative electrode is effectively depleted. The battery may then be recharged by passing a suitable direct electrical current in the opposite direction between the electrodes.

During discharge, the negative electrode may contain a comparatively high concentration of intercalated lithium, calcium, sodium, and/or potassium, which is oxidized into lithium ions, calcium ions, sodium ions, and/or potassium ions releasing electrons. Lithium ions, calcium ions, sodium ions, and/or potassium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions, calcium ions, sodium ions, and/or potassium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

### SUMMARY

In one configuration, a method for pre-forming cathode electrolyte interphase on electroactive material is provided. The method includes sourcing a current or voltage to an electrochemical reactor including a cation source, an electrolyte mixture, one or more additives, and a cathode active material in contact with one another, wherein the current or voltage serves to ionize and form cations at the cation source that reacts with the cathode active material to pre-form cathode electrolyte interphase on the cathode active material.

The method may include one or more of the following optional aspects or steps. For example, the electrolyte mixture can include the cathode active material and the method further includes preparing the electrolyte mixture by contacting the cathode active material with an electrolyte prior to being disposed in the electrochemical reactor, wherein the electrolyte mixture can include greater than or equal to about 1 gram of the cathode active material per 20 milliliters of electrolyte. The cathode active material can be a positive electrode material.

According to at least one aspect, the cathode active material can include a material selected from the group consisting of: lithium nickel manganese cobalt oxides, lithium-rich manganese-based layered oxides, or lithium manganese oxides, and any combinations thereof.

According to another aspect, the cation source can include a cation selected from the group consisting of: lithium, calcium, sodium, potassium, and any combinations thereof.

According to at least one example, the one or more additives can include a material selected from the group consisting of: lithium salt-based molecules, fluorinated organic molecules, or organic metal-based molecules.

According to another example, the current or voltage can be sourced for a period greater than or equal to about 5 hours to less than or equal to about 100 hours.

According to at least one aspect, the current or voltage can include a first current or voltage, the first current or voltage can be sourced for a first time period, and the method can further include sourcing a second current or voltage for a second time period, wherein the second current or voltage is different from the first current or voltage.

According to another aspect, the method can further include one or more filtering steps, one or more rinsing steps, or a combination of one or more filtering steps and one or more rinsing steps to collect the electroactive material from the electrolyte mixture.

According to at least one example, the method can further include one or more galvanostatic or potentiostatic steps.

In another configuration, a method for forming an electroactive material is provided. The method includes contacting a cathode active material with an electrolyte in an electrochemical reactor further including a cation source including a cation selected from the group consisting of: lithium, calcium, sodium, potassium, and combinations thereof, the electrolyte having a temperature greater than or equal to about 25° C. to less than or equal to about 150° C. The method further includes sourcing a current or voltage to the cation source in contact with the electrolyte in the electrochemical reactor to ionize and form cations that are reduced onto the cathode active material to form the electroactive material.

The method may include one or more of the following optional aspects or steps. For example, the electrolyte can include greater than or equal to about 1 gram of cathode active material per 20 milliliters of electrolyte.

According to at least one aspect, the cathode active material can include positive electroactive material selected from the group consisting of: lithium nickel manganese cobalt oxides, lithium-rich manganese-based layered oxides, or lithium manganese oxides, and any combinations thereof.

According to another aspect, the current can be sourced within the electrochemical reactor at greater than or equal to about 0.1 mA/cm² to less than or equal to about 25 mA/cm².

According to at least one example, one or more additives can be added to the electrochemical reactor including material selected from the group consisting of: lithium salt-based molecules, fluorinated organic molecules, or organic metal-based molecules.

According to another example, the current or voltage can be sourced for a period greater than or equal to about 5 hours or less than or equal to about 100 hours.

According to at least one aspect, the current or voltage can be a first current or voltage, the first current or voltage can be sourced for a first time period, and the method can further include sourcing a second current or voltage for a second time period, wherein the second current or voltage can be different from the first current or voltage.

According to another aspect, the method can further include one or more galvanostatic or potentiostatic steps.

In yet another configuration, a method for forming an electroactive material is provided. The method includes contacting a cathode active material with an electrolyte in an electrochemical reactor further including a cation source and one or more additives. The method further includes sourcing a current or voltage to the cation source in contact with the electrolyte in the electrochemical reactor at a first current or voltage for a first time period and sourcing a second current or voltage for a second time period, the second current or voltage being different from the first current or voltage.

The method may include one or more of the following optional aspects or steps. For example, the first and second time period can be greater than or equal to about 5 hours or less than or equal to about 100 hours.

### BRIEF DESCRIPTION OF THE DRAWINGS

The drawings described herein are for illustrative purposes only of selected configurations and are not intended to limit the scope of the present disclosure.

FIG. 1 is an illustration of an example electrochemical cell;

FIG. 2 is an illustration of an example electrochemical reactor for ex-situ electrochemical preformation of a cathode electrolyte interphase on electroactive materials in accordance with principles of the present disclosure;

FIG. 3A is a flow chart illustrating example methods for preforming cathode electrolyte interphases onto electroactive cathode material particles in accordance with various aspects of the present disclosure;

FIG. 3B is a flow chart illustrating example methods for preforming cathode electrolyte interphases onto electroactive cathode material particles in accordance with various aspects of the present disclosure;

FIG. 3C is a flow chart illustrating example methods for preforming cathode electrolyte interphase onto electroactive cathode material particles in accordance with various aspects of the present disclosure;

FIGS. 4A and 4B are schematic illustrations of a potentiostatic method for preforming cathode electrolyte interphase onto electroactive cathode material particles; and

FIGS. 5A and 5B are schematic illustrations of a current driven method for preforming cathode electrolyte interphase onto electroactive cathode material particles.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer-readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer-readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The principles of the present disclosure relate to electroactive materials, and more particularly, to electroactive materials with a pre-formed cathode electrolyte interphase (CEI), for use in electrochemical cells, and to methods of making and using the same. For example, the present disclosure provides methods for preforming the cathode electrolyte interphase on electroactive materials so as to mitigate low first cycle coulombic efficiency (CE) (i.e., lithium is no longer consumed by CEI formation during the first cycle). As discussed in more detail below, the inclusion of additives can induce the formation of certain CEI compositions and structures (e.g., thickness) which influence properties and performance.

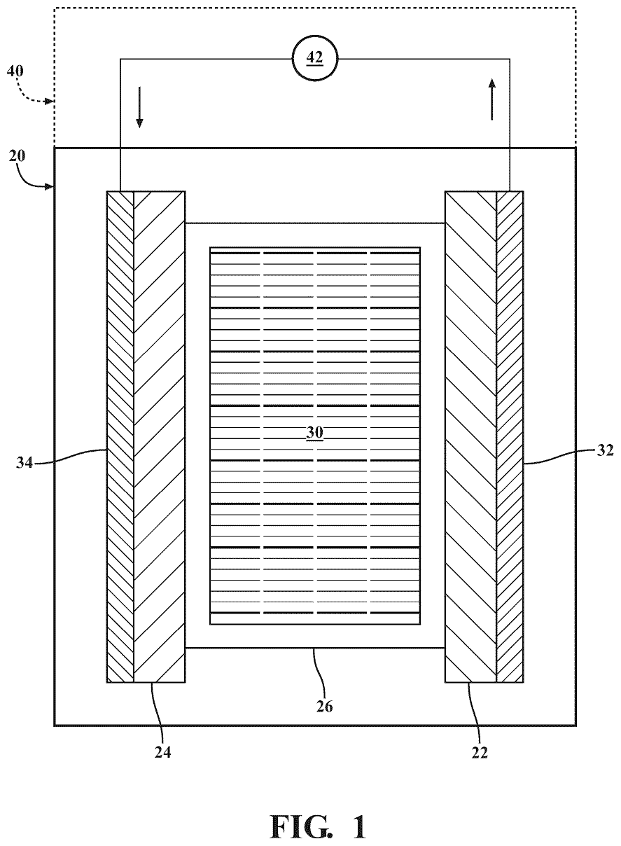

By way of background, an exemplary and schematic illustration of an electrochemical cell (also referred to as a battery) 20 is shown in FIG. 1. Although the following discussion is directed to lithium-ion electrochemical cells that cycle lithium ions, it should be appreciated that similar teachings also apply to calcium-ion electrochemical cells that cycle calcium ions, sodium-ion electrochemical cells that cycle sodium ions, and/or potassium-ion electrochemical cells that cycle potassium ions. In each instance, the electrochemical cells can be used in vehicle or automotive transportation applications (e.g., motorcycles, boats, tractors, buses, motorcycles, mobile homes, campers, and tanks). The electrochemical cells may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, it should be recognized that the present teachings also extend to various other configurations, including those having one or more cathodes and one or more anodes, as well as various current collectors with electroactive layers disposed on or adjacent to one or more surfaces thereof.

With continued reference to FIG. 1, the battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. The separator 26, like the negative electrode 22 and/or the positive electrode 24, may be in a solid and/or a liquid form and/or a hybrid thereof. For example, in certain variations, the separator 26 may include an electrolyte 30 that may also be present in the negative electrode 22 and/or the positive electrode 24. In certain variations, the separator 26 may be formed by a solid-state electrolyte or a semi-solid-state electrolyte (e.g., gel electrolyte). For example, the separator 26 may include a plurality of solid-state electrolyte particles and/or a gel electrode. The negative electrode 22 and/or the positive electrode 24 may additionally or alternatively include a plurality of solid-state electrolyte particles and/or a gel electrolyte. The solid-state electrolyte particles and/or gel electrolyte as included in, or defining, the separator 26 may be the same as or different from the solid-state electrolyte particles and/or gel electrode included in the positive electrode 24 and/or the negative electrode 22, and the solid-state electrolyte particles and/or gel electrolyte as included in the positive electrode 24 may be the same as or different from the solid-state electrolyte particles and/or gel electrolyte as included in negative electrode 22.

A first current collector 32 (e.g., a negative current collector) may be positioned at or near the negative electrode (which can also be referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode (which can also be referred to as a positive electroactive material layer) 24. The second current collector 34 together with the positive electrode 24 may be referred to as a positive electrode assembly. Although not illustrated, the skilled artisan will appreciate that, in certain variations, positive electroactive material layer 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid through a wall outlet and a motor vehicle alternator.

In many battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With continued reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, semi-solid, or gel form, capable of conducting lithium ions between the negative electrode 22 and the positive electrode 24, may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF6), lithium perchlorate (LiClO4), lithium tetrachloroaluminate (LiAlCl4), lithium iodide (LiI), lithium bromide (LiBr), lithium thiocyanate (LiSCN), lithium tetrafluoroborate (LiBF4), lithium tetraphenylborate (LiB(C6H5)4), lithium bis(oxalato) borate (LiB(C2O4)2) (LiBOB), lithium difluorooxalatoborate (LiBF2(C2O4)), lithium hexafluoroarsenate (LiAsF6), lithium trifluoromethanesulfonate (LiCF3SO3), lithium bis(trifluoromethane) sulfonylimide (LiN(CF3SO2)2), lithium bis(fluorosulfonyl)imide (LiN(FSO2)2) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separators 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous member having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al2O3), silica (SiO2), and combinations thereof. The heat-resistant material may be selected from the group consisting of: NOMEX™ meta-aramid (e.g., an aromatic polyamide formed from a condensation reaction from monomers m-phenylendiamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. For example, in certain variations, the separator 26 may be a polyolefin-based separator including, for example, polyacetylene, propylene (PP), and/or polyethylene (PE); a cellulose separator including, for example, polyvinylidene fluoride (PVDF) member and/or a porous polyimide member; and/or a high-temperature-stable separators including, for example, polyimide (PI) nanofiber-based nonwoven members, nano-sized aluminum oxide (Al2O3) and poly(lithium 4-styrenesulfonate)-coated polyethylene members silicon oxide (SiO2) coated polyethylene (PE) members, co-polyimide-coated polyethylene members, polyetherimides (PEI) (bisphenol-aceton diphthalic anhydride (BPADA) and para-phenylenediamine) members, expanded polytetrafluoroethylene reinforced polyvinylidenefluoride-hexafluoropropylene members, and/or sandwiched-structure polyvinylidene fluoride (PVDF)-poly(m-phenylene isophthalamide) (PMIA)-polyvinylidene fluoride (PVDF) members. In each instance, the separator 26 may have an average thickness greater than or equal to about 1 micrometer (tm) to less than or equal to about 50 tm, and in certain instances, optionally greater than or equal to about 1 tm to less than or equal to about 20 tm; and the electrolyte 30 may wet greater than or equal to about 5 vol. % to less than or equal to about 100 vol. %, of a total porosity of the separator 26.

In various aspects, the porous separator 26 and/or the electrolyte 30 disposed in the porous separator 26 as illustrated in FIG. 1 may be replaced with a solid-state electrolyte (“SSE”) and/or semi-solid electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24.

The solid-state electrolyte and/or semi-solid electrolyte may include a plurality of solid-state electrolyte particles. In certain variations, the electrolyte 30 may at least partially fill voids (e.g., interparticle porosity) between the solid-state electrolyte particles defining the separator 26. In each variation, the solid-state electrolyte particles may include, for example, oxide-based solid-state particles (such as garnet type solid-state particles (e.g., Li7La3Zr2O12 (LLZO)), perovskite type solid-state particles (e.g., Li3xLa2/3-xTiO3, where 0<x<0.167), NASICON type solid-state particles (e.g., Li1.4Al0.4Ti1.6(PO4)3, Lil+xAlxGe2-x(PO4)3 (where 0≤x≤2) (LAGP)), and/or LISICON type solid-state particles (e.g., Li2+2xZn1-xGeO4, where 0<x<1)), metal-doped or aliovalent-substituted oxide solid-state particles (such as aluminum (Al) or niobium (Nb) doped Li7La3Zr2O12, antimony (Sb) doped Li7La3Zr2O12, gallium (Ga) substituted Li7La3Zr2O12, chromium (Cr) and/or vanadium (V) substituted LiSn2P3O12, and/or aluminum (Al) substituted Li1+x+yAlxTi2-xSiYP3-yO12 (where 0<x<2 and 0<y<3)), sulfide-based solid-state particles (such as Li2S—P2S5 systems (e.g., Li3PS4, Li7P3S11, and Li9.6P3S12), Li2S—SnS2 systems (e.g., Li4SnS4), Li10GeP2S12 (LGPS), Li3.25Ge0.25P0.75S4 (thio-LISICON), Li3.4Si0.4P0.6S4, Li10GeP2S11.7O0.3, lithium argyrodite (Li6PS5X, where X is CL, Br, or I), Li9.54Si1.74P1.44S11.7C10.3, Li9.6P3S12, Li7P3S11, Li9P3S9O3, Li10.35Ge1.35P1.65S12, Li10.35Si1.35P1.65S12, Li9.81Sn0.81P2.18S12, Li10(Si0.5Ge0.5)P2S12, Li10(Ge0.5Sn0.5)P2S12, Li10(Si0.5Sn0.5)P2S12, Li3.933Sn0.833As0.166S4, LiI—Li4SnS4, and/or Li4SnS4), nitride-based solid-state particles (such as Li3N, Li7PN4, and/or LiSi2N3), hydride-based solid-state particles (such as LiBH4, LiBH4-LiX (where X=Cl, Br, or I), LiNH2, Li2NH, LiBH4-LiNH2, and/or Li3AlH6), halide-based solid-state particles (such as Li3YCl6, Li3InCl6, Li3YBr6, LiI, Li2CdCl4, Li2MgCl4, LiCdI4, Li2ZnI4, and/or Li3OCl), and/or borate-based solid-state particles (Li2B4O7 and/or Li2O—B2O3-P2O5).

The semi-solid electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The liquid electrolyte may be like the electrolyte 30 detailed above. In certain variations, the semi-solid or gel electrolyte may also be found in the negative electrode 22 and/or positive electrode 24.

With reference again to FIG. 1, the positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24 (i.e., within voids or spaces between the positive electroactive material particles). In certain variations, the positive electrode 24 may include a plurality of solid-state electrolyte particles dispersed with the positive electroactive material particles. The electrolyte 30 may at least partially fill voids or spaces between the positive electroactive material particles and the solid-state electrolyte particles. In each instance, the positive electrode 24 may have an average thickness greater than or equal to about 30 μm to less than or equal to about 500 μm, and in certain aspects, optionally greater than or equal to about 50 μm to less than or equal to about 100 μm.

In various aspects, the positive electroactive material includes a layered oxide represented by LiMeO2, where Me is a transition metal, such as cobalt (Co), nickel (Ni), manganese (Mn), iron (Fe), aluminum (Al), vanadium (V), or combinations thereof. In other variations, the positive electroactive material includes a polyanion oxide represented by LiMePO4, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li3Me2(PO4)3, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe2O4, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO4F and/or LiMePO4F, where Me is a transition metal, such as cobalt (Co), nickel (Ni), manganese (Mn), iron (Fe), aluminum (Al), vanadium (V), or combinations thereof.

In still further variations, the positive electrode 24 may be a composite electrode including a combination of positive electroactive materials. For example, the positive electrode 24 may include a first positive electroactive material and a second electroactive material. A mass ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may be lithiated prior to or after incorporating into the positive electrode 24 and/or the battery 20 to help to compensate for lithium loses during cycling, such as may result during conversion reactions and/or a cathode-electrolyte interphase (CEI) layer on the positive electrode 24 during the first cycle, as well as ongoing lithium loss due to, for example, continuous cathode-electrolyte interphase (CEI) layer formation.

In each variation, the positive electroactive material may be optionally intermingled with an electronically conductive material (i.e., conductive additive) that provides an electron conductive path and/or a polymeric binder material that improves the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene (PVdF), difluoride poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and/or styrene copolymers (SEBS). Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 is formed from a lithium host material that is capable of functioning as a negative terminal of a lithium-ion battery. In various aspects, the negative electrode 22 may be defined by a plurality of negative electroactive material particles. The negative electroactive material particles may be disposed in one or more layers so as to define the three-dimensional structure of the negative electrode 22. The electrolyte 30 may be introduced, for example after cell assembly, and contained within pores of the negative electrode 22 (i.e., within voids or spaces between the negative electroactive material particles). In certain variations, the negative electrode 22 may include a plurality of solid-state electrolyte particles dispersed with the negative electroactive material particles. The electrolyte 30 may at least partially file voids or spaces between the negative electroactive material particles and the solid-state electrolyte particles. In each instance, the negative electrode 22 may have an average thickness greater than or equal to about 30 μm to less than or equal to about 500 μm, and in certain aspects, optionally greater than or equal to about 50 μm to less than or equal to about 100 μm.

In certain variations, the negative electroactive material particles may include silicon-containing (or silicon-based) electroactive materials. The silicon-containing electroactive materials may include silicon, lithium-silicon alloys, and other silicon-containing binary and/or ternary alloys. For example, in certain variations, the silicon-containing electroactive material may include elemental silicon (Si), various lithium silicide phases (LixSiy, where 0<x<17 and 1<y<4), silicon nanograins embedded in a silicon oxide (SiOₓ, where 0<x<2) matrix, lithium doped silicon oxide (LiySiOx, where 0<x<2 and 0<y<1), and combinations thereof. The silicon-containing electroactive materials may be provided as nano-particles, nano-fibers, nano-tubes, and/or micro-particles.

In other variations, the negative electrode 22 may include one or more other alloying anode materials such as aluminum, germanium, tin, antimony, and/or bismuth). In still other variations, the negative electrode 22 may include a lithium-containing negative electroactive material, such as a lithium alloy and/or a lithium metal. For example, in certain variations, the negative electrode 22 may be defined by a lithium metal foil. In still other variations, the negative electrode 22 may include, for example only, carbonaceous negative electroactive materials (such as, graphite, hard carbon, soft carbon, and the like) and/or metallic active materials (such as tin, aluminum, magnesium, germanium, and alloys thereof, and the like).

In still other variations, the negative electrode 22 may be a composite electrode including a combination of negative electroactive materials. For example, the negative electrode 22 may include a first negative electroactive material and a second negative electroactive material. A ratio of the first negative electroactive material to the second negative electroactive material may be greater than or equal to about 5:95 to less than or equal to about 95:5. In certain variations, the first negative electroactive material may be an alloying anode material including, for example, silicon, aluminum, germanium, and/or tin; and the second negative electroactive material may include a carbonaceous material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite.

In each variation, the negative electroactive material may lithiated prior to or after incorporating into the negative electrode 22 and/or the battery 20 to help to compensate for lithium loses during cycling, such as may result during conversion reactions and/or the formation of LixSi and/or a solid electrolyte interphase (SEI) layer (not shown) on the negative electrode 22 during the first cycle, as well as ongoing lithium loss due to, for example, continuous solid electrolyte interphase (SEI) formation.

The negative electroactive material may also be optionally intermingled with an electronically conductive material (i.e., conductive additive) that provides an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder. The conductive additive and/or binder as included in the negative electrode 22 may be the same as or different from the conductive additive and/or binder as included in the positive electrode 24.

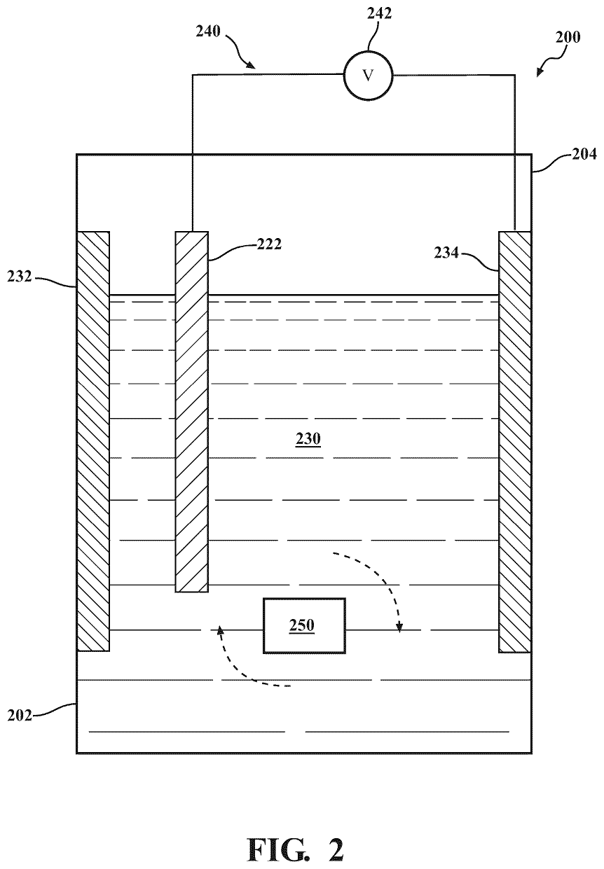

In various aspects, the present disclosure provides apparatuses and methods for pre-forming cathode electrolyte interphase on the positive electrode materials for use in electrochemical cells, like battery 20 illustrated in FIG. 1. For example, FIG. 2 illustrates an example electrochemical reactor (e.g., electrochemical stir-tank) 200, which may be a batch or continuous reactor, for ex-situ electrochemical preforming cathode-electrolyte interphase (CEI) on positive electroactive materials. The tank 200 is configured to contain or carry an electrolyte 230, which may be a liquid that is continuously or intermittently replenished or replaced. For example, in certain variations, the tank 200 may also include an agitator 250 configured to cause movement of the electrolyte 230. The electrolyte 230 may include a lithium-containing salt and an organic solvent or a mixture of organic solvents like the electrolyte 30 detailed above in the context of FIG. 1.

The tank 200 may be a conductive vessel including one or more electrically conductive components, like electrically conductive current collectors 232, 234, disposed near or along one or more sides. For example, as illustrated, the tank 200 may include a first current collector 232 disposed along a first side 202 of the tank 200 and a second current collector 234 disposed along a second side 204 of tank 200. The first current collector 232 and the second current collector 234 each contact the electrolyte 230. The one or more current collectors 232, 234 may be high-surface area current collectors, made of copper, platinum, silver, etc. For example, the one or more current collectors 232, 234 may have surface areas (i.e., roughness factor) greater than or equal to about 1 cm²/(cm² geometric) to less than or equal to about 10 cm²/(cm² geometric).

The tank 200 may also include an additional cation source, such as a lithium source 222, where the cation is lithium. The lithium source 222 is at least partially disposed within the electrolyte 230 in the tank 200 and is in electrical communication with one of the one or more current collectors 232, 234. In certain variations, as illustrated, the lithium source 222 may be in electrical communication with a second current collector 234. For example, an interruptible external circuit 240 and a load device or voltage source 242 may be connected to the lithium source 222 and the second current collector 234. The lithium source 222 may have a variety of configurations including, for example, metal foils, foams, and/or rods, as well as, or alternatively, cathode materials and/or lithiated graphite. For example, in certain variations, the lithium source 222 may be a solid material, such as a strip of lithium metal.

Although not illustrated, it should be appreciated that the electrochemical stir-tank 200 may include various other components as known to those skilled in the art, including, for example, a motor in communication with the agitator, an inlet, an outlet, ports, associated piping, pressure, temperature, and voltameter/ammeter monitors and control systems, and the like.

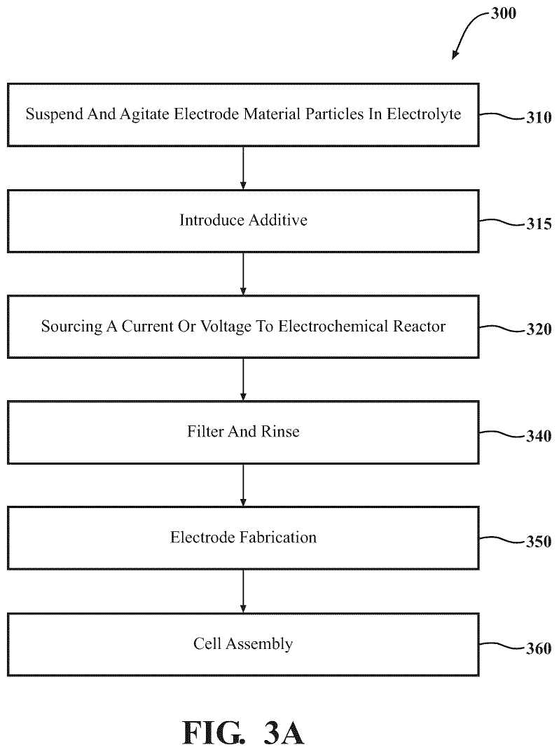

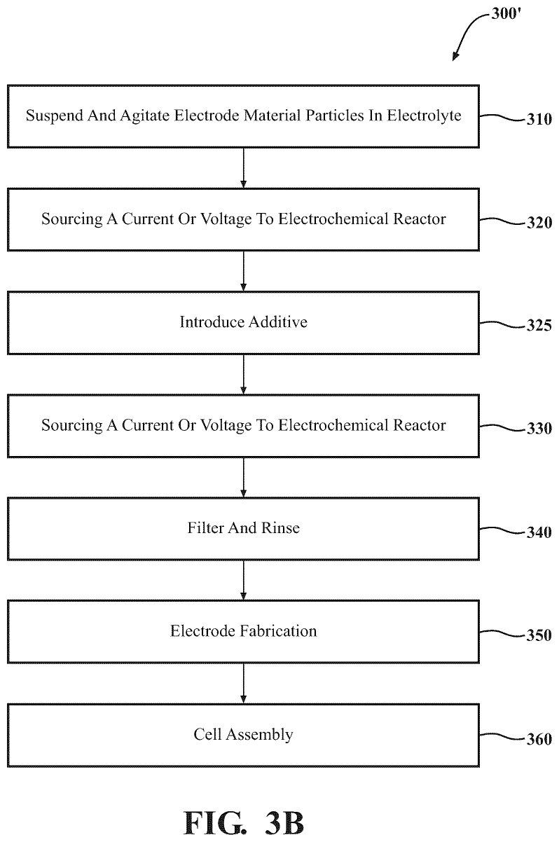

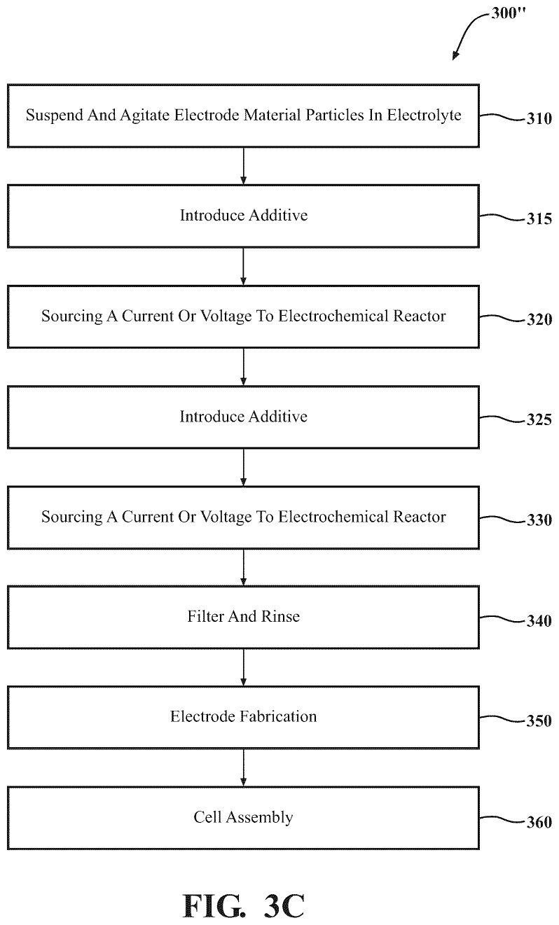

FIG. 3A illustrates an example method for preforming cathode electrolyte interphase on electroactive material using an electrochemical stir-tank, like the electrochemical stir-tank 200 illustrated in FIG. 2. The method 300 may include contacting 310 an electroactive material or cathode active material (CAM) (e.g., an electroactive cathode powder) 312 and the electrolyte 230. For example, in certain variations, the method 300 may include dispersing (e.g., suspending) in the electrolyte. The cathode active material includes a plurality of electroactive cathode material particles (e.g., Lithium Cobalt Oxide (LCO), Lithium Nickel Manganese Cobalt Oxide (NMC), Lithium Nickel Manganese Cobalt Aluminum Oxide (NMCA), Lithium Nickel Manganese Oxide (LNMO), Lithium iron phosphate (LFO), Lithium Manganese Rich (LMR), or Lithium Titanium Oxide (LTO), for example.

In certain variations, the cathode active material may be added to the electrochemical stir-tank 200 holding the electrolyte 230. In other variations, the cathode active material may be added to the electrolyte 230 prior to, or as, the electrolyte 230 is added to the electrochemical stir-tank 200. In each instance, the as-formed suspension may include greater than or equal to about 1 gram (g) of the cathode active material per 20 milliliters (mL) of electrolyte 230 and the electrolyte 230 may have a temperature greater than or equal to about 25° C. to less than or equal to about 150° C., and in certain aspects, optionally greater than or equal to about 40° C. to less than or equal to about 150° C., such that the preforming cathode electrolyte interphase method can be considered a low-temperature process.

Current may be driven (or voltage may be supplied) to the electrochemical reactor 200 and depending on the runtime, a thickness of CEI may be formed on the electroactive cathode material particles. One or more additives may be added to the electrolyte to change the electrolyte chemistry either before or during the current being driven (or voltage supplied) to the electrochemical reactor 200.

In certain variations, the method 300 includes sourcing or applying 320 a current or voltage between the lithium source 222 and the second current collector 234 to preform cathode electrolyte interphase on the electroactive cathode material particles.

With reference to FIG. 3A, at 310, cathode active material is suspended in the electrolyte 230. The agitator 250 may be used to agitate the cathode active material within the electrolyte.

At 315, one or more additives introduced above may be added to the electrochemical reactor 200.

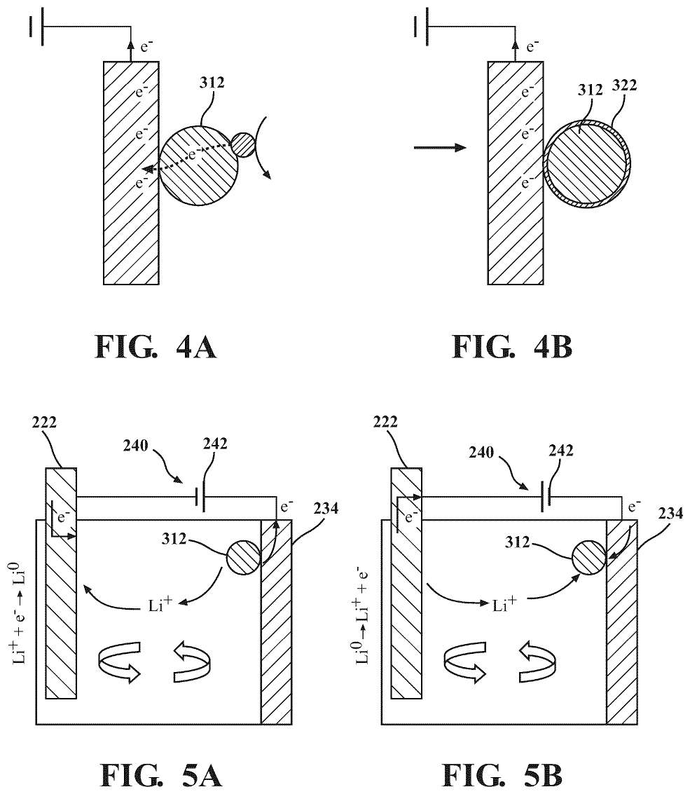

At 320, a current may be driven (or voltage may be supplied) to the electrochemical reactor 200. With reference to FIGS. 4A and 4B, a voltage may be supplied to the electrochemical reactor 200 to induce electrolyte and/or additive breakdown. With reference to FIGS. 5A and 5B and according to another aspect of the present disclosure, current may be driven to the electrochemical reactor 200 and between the lithium source 222 and the second electrically conductive current collector 234 to de-lithiate and re-lithiate (i.e., cycle) cathode active material. According to one aspect, the current sourced within the electrochemical reactor is greater than or equal to about 0.1 mA/cm² to less than or equal to about 25 mA/cm². The current or voltage can serve to ionize and form cations at the cation source that react with the cathode active material to pre-form a cathode electrolyte interphase layer 322 on the cathode active material.

At 340, the cathode active material having the cathode electrolyte interphase layer 322 may be filtered from the electrolyte 230 and rinsed. According to one aspect, the electrolyte may be used to rinse the electroactive cathode material 312 having cathode electrolyte interphase layers 322. According to another aspect, the electrolyte can be reused for further processing in the electrochemical reactor 200. The electrolyte can include a solvent, such as Dimethyl Carbonate (DMC), Ethylene Carbonate (EC), Diethyl Carbonate (DEC), Propylene Carbonate (PC), Ethyl Methyl Carbonate (EMC), Dimethyl Sulfoxide (DMSO), Ethyl Acetate (EA), γ-Butyrolactone (GBL), 1,2-Dimethoxyethane (DME), Tetraethylene Glycol Dimethyl Ether (TEGDME), or Diethyl carbonate Tetramethylene sulfone, for example. Additionally or alternatively, the electrolyte can include a salt, such as Lithium Hexafluorophosphate (LiPF₆), Lithium bis(fluorosulfonyl)imide) (LiFSI), Lithium bis(flurosulonyl) imide (LiTFSI), Lithium tetrafluoroborate (LiBF₄), Lithium perchlorate (LiClO₄), Lithium bis(oxalate)borate (LiBOB), or LiODF, for example.

At 350, an electrode may be fabricated using the electroactive cathode material particles 312 having the cathode electrolyte interphase layer 322.

At 360, a cell comprising one or more electrodes may be assembled.

With reference to FIG. 3B, method 300′ is provided. In general, the method 300′ is similar to method 300. In method 300′, however, after 310, current is driven (or voltage is supplied) to the electrochemical reactor 200 to induce electrolyte breakdown at 320 before any additive is introduced to the electrochemical reactor.

At 325, one or more additives is introduced to the electrochemical reactor 200, such as Fluoroethylene carbonate (FEC), Vinylene carbonate (VC), Tetraethoxysilane (TEOS), (2-cyanoethyl) triethoxysilane (TEOSCN), Dimethylacrylamide (DMAA), and/or Methyl (2,2,2-trifluoroethyl) carbonate (FEMC), for example.

At 330, current is driven (or voltage is supplied) to the electrochemical reactor 200 to induce further breakdown of the electrolyte and breakdown of the one or more additives that were added to the electrochemical reactor. According to one aspect, the current sourced within the electrochemical reactor is greater than or equal to about 0.1 mA/cm² to less than or equal to about 25 mA/cm².

The method 300′ can follow one or more of the remaining steps of method 300.

With reference to FIG. 3C, method 300″ is provided for preforming two or more layers of cathode electrolyte interphase onto the electroactive cathode material particles. In general, method 300″ is similar to methods 300 and 300′. However, in order to form more than one layer of CEI onto electroactive cathode material particles additive is added to the electrochemical reactor at 315 and 325 followed by current being driven (or voltage supplied) to the electrochemical reactor more than once (e.g., at 320 and 330). In other words, multiple additive steps can be introduced sequentially. According to one aspect, the electroactive cathode material particles may be rinsed before more additive is added and before current is driven (or voltage is supplied) to the electrochemical reactor.

The methods 300, 300′, 300″ can include one or more galvanostatic or potentiostatic steps.

A number of implementations have been described. Nevertheless, it will be understood that various modifications may be made without departing from the spirit and scope of the disclosure. Accordingly, other implementations are within the scope of the following claims.

The foregoing description has been provided for the purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method for pre-forming cathode electrolyte interphase on electroactive material, the method comprising:
sourcing a current or voltage to an electrochemical reactor comprising a cation source, an electrolyte mixture, one or more additives, and a cathode active material in contact with one another, wherein the current or voltage serves to ionize and form cations at the cation source that reacts with the cathode active material to pre-form cathode electrolyte interphase on the cathode active material.

2. The method of claim 1, wherein the electrolyte mixture comprises the cathode active material and the method further comprises:
preparing the electrolyte mixture by contacting the cathode active material with an electrolyte prior to being disposed in the electrochemical reactor, wherein the electrolyte mixture comprises greater than or equal to about 1 gram of the cathode active material per 20 milliliters of electrolyte.

3. The method of claim 2, wherein the cathode active material is a positive electrode material.

4. The method of claim 3, wherein the cathode active material comprises a material selected from the group consisting of: lithium nickel manganese cobalt oxides, lithium-rich manganese-based layered oxides, or lithium manganese oxides, and any combinations thereof.

5. The method of claim 2, wherein the cation source comprises a cation selected from the group consisting of: lithium, calcium, sodium, potassium, and any combinations thereof.

6. The method of claim 2, wherein the one or more additives comprises material selected from the group consisting of: lithium salt-based molecules, fluorinated organic molecules, or organic metal-based molecules.

7. The method of claim 1, wherein the current or voltage is sourced for a period greater than or equal to about 5 hours to less than or equal to about 100 hours.

8. The method of claim 1, wherein the current or voltage is a first current or voltage, the first current or voltage is sourced for a first time period, and the method further comprises sourcing a second current or voltage for a second time period, wherein the second current or voltage is different from the first current or voltage.

9. The method of claim 1, wherein the method further comprises one or more filtering steps, one or more rinsing steps, or a combination of one or more filtering steps and one or more rinsing steps to collect the electroactive material from the electrolyte mixture.

10. The method of claim 1, wherein the method further comprises one or more galvanostatic or potentiostatic steps.

11. A method for forming an electroactive material, the method comprising:
contacting a cathode active material with an electrolyte in an electrochemical reactor further comprising a cation source comprising a cation selected from the group consisting of: lithium, calcium, sodium, potassium, and combinations thereof, the electrolyte having a temperature greater than or equal to about 25° C. to less than or equal to about 150° C.; and
sourcing a current or voltage to the cation source in contact with the electrolyte in the electrochemical reactor to ionize and form cations that are reduced onto the cathode active material to form the electroactive material.

12. The method of claim 11, wherein the electrolyte comprises greater than or equal to about 1 gram of cathode active material per 20 milliliters of electrolyte.

13. The method of claim 11, wherein the cathode active material comprises positive electroactive material selected from the group consisting of: lithium nickel manganese cobalt oxides, lithium-rich manganese-based layered oxides, or lithium manganese oxides, and any combinations thereof.

14. The method of claim 11, wherein the current is sourced within the electrochemical reactor at greater than or equal to about 0.1 mA/cm² to less than or equal to about 25 mA/cm².

15. The method of claim 11, further comprising one or more additives being added to the electrochemical reactor comprising material selected from the group consisting of: lithium salt-based molecules, fluorinated organic molecules, or organic metal-based molecules.

16. The method of claim 11, wherein the current or voltage is sourced for a period greater than or equal to about 5 hours or less than or equal to about 100 hours.

17. The method of claim 11, wherein the current or voltage is a first current or voltage, the first current or voltage is sourced for a first time period, and the method further comprises sourcing a second current or voltage for a second time period, wherein the second current or voltage is different from the first current or voltage.

18. The method of claim 11, wherein the method further comprises one or more galvanostatic or potentiostatic steps.

19. A method for forming an electroactive material, the method comprising:
contacting a cathode active material with an electrolyte in an electrochemical reactor further comprising a cation source and one or more additives, and
sourcing a current or voltage to the cation source in contact with the electrolyte in the electrochemical reactor at a first current or voltage for a first time period and sourcing a second current or voltage for a second time period, the second current or voltage being different from the first current or voltage.

20. The method of claim 19, wherein the first and second time period is greater than or equal to about 5 hours or less than or equal to about 100 hours.
